(19) United States
(12) Patent Application Publication
(10) Pub. No.: US 2019/0130377 A1
(43) Pub. Date: May 2, 2019

(54) AUTOMATIC BILLING SYSTEM, AUTOMATIC BILLING METHOD AND NON-TRANSITORY RECORDING MEDIUM

(71) Applicants: BEIJING KUANGSHI TECHNOLOGY CO., LTD., Beijing (CN); MEGVII (BEIJING) TECHNOLOGY CO., LTD., Beijing (CN)

(72) Inventors: Yuchun DING, Beijing (CN); Danqing LIU, Beijing (CN); Pengfei ZHENG, Beijing (CN)

(21) Appl. No.: 16/175,298

(22) Filed: Oct. 30, 2018

(30) Foreign Application Priority Data
Nov. 1, 2017 (CN) 201711060946.7

(51) Int. Cl. G06Q 20/20; G07G 1/00; G07G 1/12; G06K 9/00

(52) U.S. Cl. CPC G06Q 20/208; G06Q 20/201; G06K 9/00624; G07G 1/0072; G07G 1/12; G07G 1/0063

(57) ABSTRACT

This disclosure provides an automatic billing system and an automatic billing method, and relates to the field of intelligent billing technologies, the automatic billing method is executed by a billing terminal, the method includes: receiving physical information of the items to be checked out acquired by the physical information acquiring device, the physical information including weight and/or volume; receiving image information of the items to be checked out acquired by the image acquiring device; determining identity information of the items to be checked out according to the image information of the items to be checked out; verifying whether the identity information of the items to be checked out is correct according to the physical information of the items to be checked out; and if correct, proceeding to checkout of the items to be checked out.

### CROSS-REFERENCE TO RELATED APPLICATION

The present application claims the priority of Chinese patent application No. 201711060946.7 filed on Nov. 1, 2017, the disclosure of which is incorporated herein by reference in its entirety.

### TECHNICAL FIELD

The present disclosure relates to the field of intelligent billing technologies, and more particularly, to an automatic billing system, an automatic billing method and a non-transitory recording medium.

### BACKGROUND

The current supermarkets, convenience stores, shopping malls and other physical shopping facilities still adopt the manual billing manner, that is, consumers need to go to the checkout counter, and items purchased by consumers are charged by cashiers. This manual billing manner is time-consuming and laborious, and may also be affected by factors such as a small number of cashiers and low checkout efficiency of cashiers, consumers may need to spend a long time on the checkout process and have bad experience.

With the development of smart retail, automatic billing devices have gradually appeared in some shopping places. Most of the existing automatic billing devices adopt an item scanning manner or an electronic tag manner such as RFID (Radio Frequency Identification) to confirm item identity. However, the scanning manner requires the consumers to cooperate initiatively, and it is relatively cumbersome to scan items one by one; whereas cost of the RFID manner is relatively high, if each low-margin item is attached with an RFID electronic tag, it will obviously affect the vendor's profit, it is economically unaffordable for the vendor, thus there is no ubiquitous applicability.

### SUMMARY

In view of this, the objectives of the present disclosure are to provide an automatic billing system and an automatic billing method, which can achieve automatic billing without cumbersome operations such as manual cooperative scanning, without the requirement to attach an electronic label with a relatively high cost to items, hereby ubiquitous applicability of items available for automatic billing is raised at a reasonable cost, and it is suitable for promotion and spreading.

In order to achieve the above objectives, the technical solutions adopted by the embodiments of the present disclosure are as follows:

An embodiment of the present disclosure provides an automatic billing system, comprising: a billing terminal, as well as a physical information acquiring device and an image acquiring device connected to the billing terminal respectively; the physical information acquiring device is configured to acquire physical information of items to be checked out, and send the acquired physical information to the billing terminal; the physical information including weight and/or volume; the image acquiring device is configured to acquire image information of the items to be checked out, and send the acquired image information of the items to be checked out to the billing terminal; the billing terminal is configured to determine identity information of the items to be checked out according to the acquired image information of the items to be checked out, and further, to verify whether the identity information of the items to be checked out is correct according to the acquired physical information of the items to be checked out; if correct, proceed to checkout of the items to be checked out.

An embodiment of the present disclosure further provides an automatic billing method, the method being applied to an automatic billing system that includes a billing terminal as well as a physical information acquiring device and an image acquiring device connected to the billing terminal respectively; the method being executed by the billing terminal, the method comprising: receiving physical information of the items to be checked out acquired by the physical information acquiring device, the physical information including weight and/or volume; receiving image information of the items to be checked out acquired by the image acquiring device; determining identity information of the items to be checked out according to the image information of the items to be checked out; verifying whether the identity information of the items to be checked out is correct according to the physical information of the items to be checked out; and if correct, proceeding to checkout of the items to be checked out.

An embodiment of the present disclosure provides a non-transitory recording medium on which a computer program is stored, wherein steps of an automatic billing method are executed when the computer program is run by a processing device, the method being applied to an automatic billing system that includes a billing terminal as well as a physical information acquiring device and an image acquiring device connected to the billing terminal respectively, the method comprising: receiving physical information of the items to be checked out acquired by the physical information acquiring device, the physical information including weight and/or volume; receiving image information of the items to be checked out acquired by the image acquiring device; determining identity information of the items to be checked out according to the image information of the items to be checked out; verifying whether the identity information of the items to be checked out is correct according to the physical information of the items to be checked out; and if correct, proceeding to checkout of the items to be checked out.

The embodiments of the present disclosure provide an automatic billing system and an automatic billing method, physical information of items to be checked out is acquired by the physical information acquiring device, image information of the items to be checked out is acquired by the image acquiring device, identity information of the items to be checked out is recognized according to the image information, and whether the identity information is correct is further verified by adopting the physical information, if correct, it proceeds to checkout of the items to be checked out. This automatic billing manner determines item identity by way of image recognition, and verifies item identity through physical information such as weight, volume, etc., to ensure accuracy of item identification. Automatic billing can be achieved without cumbersome operations such as manual cooperative scanning, without the requirement to attach an electronic label with a relatively high cost to items, thereby ubiquitous applicability of items available for automatic billing is raised at a reasonable cost, and it is suitable for promotion and spreading.

Other features and advantages of the present disclosure will be set forth in the description which follows, or parts of the features and advantages may be deferred from the specification or be determined undoubtedly therefrom or be learned by implementing the above techniques of the present disclosure.

For the above described objectives, features, and advantages of the present disclosure to be more apparent and understandable, preferred embodiments will be illustrated below in combination with the drawings, so as to provide detailed explanation as follows.

### BRIEF DESCRIPTION OF THE DRAWINGS

In order to more clearly illustrate the specific implementations of the present disclosure or the technical solutions in the prior art, drawings necessary for describing the specific implementations or the prior art will be briefly introduced below, obviously, the following drawings are parts of the implementations of the present disclosure, and for a person of ordinary skill in the art, it is possible to attain other drawings based on these drawings without paying creative effort.

FIG. 1 shows a schematic diagram of structure of a billing terminal according to an embodiment of the present disclosure;

FIG. 2 shows a schematic diagram of structure of an automatic billing system according to an embodiment of the present disclosure;

FIG. 3 shows a flowchart of an automatic billing method provided by an embodiment of the present disclosure;

FIG. 4 shows a schematic view of installation of a distance sensor on a shelf according to an embodiment of the present disclosure;

FIG. 5 shows a schematic diagram of application of an automatic billing system according to an embodiment of the present disclosure;

FIG. 6 shows a flowchart of automatic billing method provided by an embodiment of the present disclosure; and

FIG. 7 shows a schematic diagram of a non-transitory recording medium provided by an embodiment of the present disclosure.

### DETAILED DESCRIPTION OF THE EMBODIMENTS

To make the objectives, technical solutions, and advantages of the present disclosure be more clear and obvious, hereinafter, the technical solutions of the present disclosure will be described clearly and comprehensively in combination with the drawings, obviously, these described embodiments are parts of the embodiments of the present disclosure, rather than all of the embodiments thereof. All the other embodiments obtained by a person of ordinary skill in the art based on the embodiments of the present disclosure without paying creative efforts fall into the protection scope of the present disclosure.

At present, the automatic billing system of shopping facilities most adopts the cumbersome manual cooperative scanning manner or a high-cost electronic label attachment manner, in order to make improvement with respect to this, the embodiments of the present disclosure provide an automatic billing system and an automatic billing method, this technology can be implemented by using corresponding software and hardware, and can be applied to trading places where items need to be charged and checked out, such as shopping malls, supermarkets, convenience stores, factories etc., and the embodiments of the present disclosure will be are described in detail below.

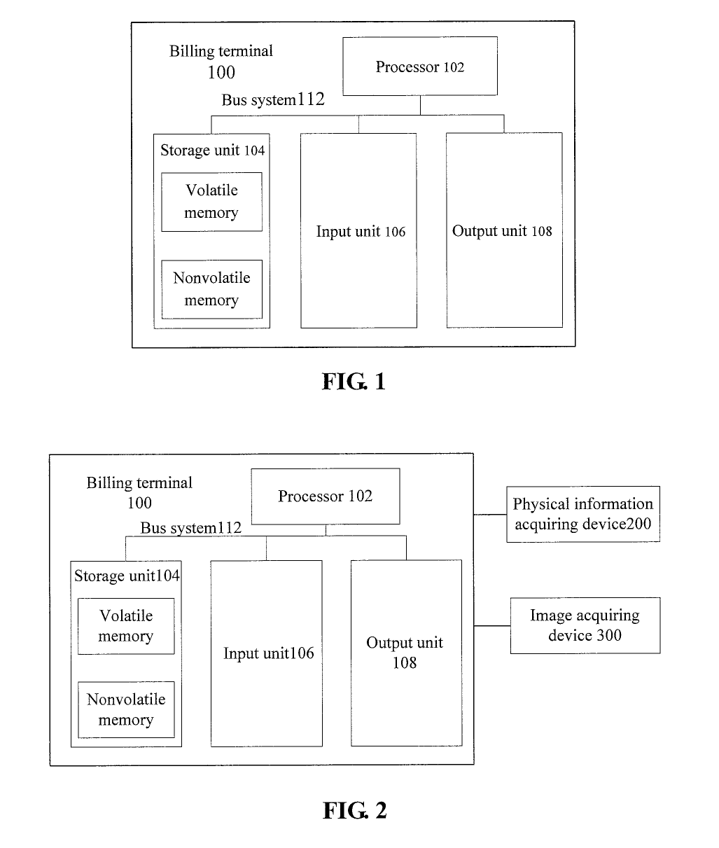

First, an example billing terminal 100 for implementing the automatic billing system and the automatic billing method according to an embodiment of the present disclosure will be described with reference to FIG. 1.

FIG. 1 shows a schematic diagram of structure of a billing terminal, the billing terminal 100 comprises one or more processors 102, one or more storage units 104, an input unit 106 and an output unit 108, these components are interconnected through a bus system 112 and/or other forms of connection mechanisms (not shown). It should be noted that, components and structures of the billing terminal 100 shown in FIG. 1 are merely exemplary, not restrictive, and the billing terminal may have other components and structures as needed.

The processor 102 may be a central processing unit (CPU) or other forms of processing unit with data processing capability and/or instruction execution capability, and can control other components in the billing terminal 100 to perform desired functions.

The storage unit 104 may include one or more computer program products, said computer program products may include various forms of computer-readable storage medium, such as a volatile memory and/or a nonvolatile memory. The volatile memory may include, for example, a random access memory (RAM) and/or a cache or the like. The nonvolatile memory may include, for example, a read only memory (ROM), a hard disk, a flash memory or the like. One or more computer program instructions may be stored on the computer-readable storage medium, and the processor 102 may execute the program instructions to implement client functions (implemented by the processor) in embodiments of the present disclosure described below and/or other desired functions. Various application programs and various data may also be stored in the computer-readable storage medium, such as various data used and/or generated by the application programs or the like.

The input unit 106 may be a device used by a user to input an instruction, and may include one or more of a keyboard, a mouse, a microphone, a touch screen or the like.

The output unit 108 may output various types of information (e.g., image or sound) to the outside (e.g., a user), and may include one or more of a display, a speaker or the like.

Exemplarily, an example billing terminal for implementing the automatic billing system and the automatic billing method according to an embodiment of the present disclosure may be implemented as a smart terminal such as a host computer, a computer, a smart phone, a tablet or the like.

An example automatic billing system for implementing the automatic billing system and the automatic billing method according to an embodiment of the present disclosure will be described with reference to FIG. 2 on the basis of FIG. 1.

FIG. 2 shows a schematic diagram of structure of an automatic billing system, based on the billing terminal 100 shown in FIG. 1, the automatic billing system further comprises a physical information acquiring device 200 and an image acquiring device 300 connected to the billing terminal 100.

The physical information acquiring device 200 is configured to acquire physical information such as weight and volume of the items to be checked out, and may be implemented by adopting a weight sensing component, a volume detecting component or the like. The acquired physical information is sent to the billing terminal 100 for use by the billing terminal 100.

The image acquiring device 300 may capture an image desired by the user (e.g., a photo, a video, etc.), and send the captured image to the billing terminal 100 for use by the billing terminal 100.

This embodiment of the present disclosure provides an automatic billing system, as shown in FIG. 2, comprising: a billing terminal 100, as well as a physical information acquiring device 200 and an image acquiring device 300 connected to the billing terminal 100 respectively;

the physical information acquiring device 200 is configured to acquire physical information of items to be checked out, and send the acquired physical information to the billing terminal 100; the physical information including weight and/or volume;

the image acquiring device 300 is configured to acquire image information of the items to be checked out, and send the acquired image information of the items to be checked out to the billing terminal 100;

the billing terminal 100 is configured to determine identity information of the items to be checked out according to the acquired image information of the items to be checked out, and further, to verify whether the identity information of the items to be checked out is correct according to the acquired physical information of the items to be checked out; if correct, proceed to checkout of the items to be checked out.

The automatic billing system provided above by the embodiment of the present disclosure acquires physical information of the items to be checked out by the physical information acquiring device, and acquires image information of the items to be checked out by the image acquiring device, recognizes identity information of the items to be checked out according to the image information, and further verifies whether the identity information is correct by adopting the physical information, if correct, it proceeds to checkout of the items to be checked out. This automatic billing manner determines item identity by way of image recognition, and verifies item identity through physical information such as weight, volume, etc., to ensure accuracy of item identification. Automatic billing can be achieved without cumbersome operations such as manual cooperative scanning, without the requirement to attach an electronic label with a relatively high cost to items, thereby ubiquitous applicability of items available for automatic billing is raised at a reasonable cost, and it is suitable for promotion and spreading.

In practical applications, the physical information acquiring device may include a weight detecting section and/or a volume detecting section. The weight detecting section is configured to acquire weight of the items to be checked out, and may be implemented by adopting a gravity sensor or the like. The volume detecting section is configured to acquire volume of the items to be checked out, and specifically, may be implemented by adopting measuring grating (which may also be a measuring light curtain), and/or an opposite-type photoelectric sensor array.

Specifically, the opposite-type photoelectric sensor includes two parts, a light emitter and a light receiver, which are separated from each other and disposed opposite to each other, and the opposite-type photoelectric sensor array may be used to detect the volume of the items. The measuring grating is also a special type of photoelectric sensor, and may also be used to detect the volume of the items. Like the opposite-type photoelectric sensor, it also includes two parts, the light emitter and the light receiver, which are separated from each other and placed opposite to each other, but its outer shape is large and it is long tubular. Unlike an ordinary photoelectric sensor, detection light beams generated by the light emitter of the measuring grating is not a bundle, instead it produces a light array at a fixed distance along a length direction to form a light curtain, which achieves the function of detecting and measuring external dimensions of the items by way of scanning, in cooperation with a controller and its software.

The person intended for checkout (that is, the consumer who is being for checkout) places the items to be checked out, and a certain distance may be set away from the packaging area, so the automatic billing system may further include a conveying device configured to convey the items to be checked out. That is, the items to be checked out are transferred from a starting position at which the items to be checked out are processed by the automatic billing system to the package area.

Considering that there may be more than one item to be checked out, a plurality of items to be checked out may easily stack, thus, the conveying device further includes a differential steering conveying device configured to separate a plurality of stacked items to be checked out in the process of conveying the items to be checked out. The differential steering conveying device mainly separates stacked items based on the principle of speed difference, and it help in terms of subsequently acquiring physical information such as the volume of a single item to be checked out.

In an implementation, the differential steering conveying device is implemented by adopting a differential steering conveyor belt, wherein the differential steering conveyor belt may be composed by two or more parallel conveyor belts, one is a fixed speed conveyor and the other is a variable speed conveyor, a controller achieves steering and outward rotation of the items by controlling the variable speed conveyor, thus the stacked items are separated from each other.

In another implementation the differential steering conveying device is implemented by adopting a differential steering delivery wheel. Specifically, it may be a dual planetary differential speed steering system, and the differential steering delivery wheel may also be provided with a differential mechanism or other components, so as to better achieve the differential steering function. Of course, the differential steering conveying device may also be implemented by other configurations capable of implementing differential transmission, details are not repeated herein again.

In order to further ensure separation of the stacked items to be checked out to ensure accuracy of volume measurement of each item to be checked out, the conveying device is also provided with a robot arm for separating the plurality of stacked items to be checked out. The robot arm may separate the stacked items from each other by disturbing the items at an arm end. Specifically, the robot arm may also be implemented by adopting a resilient arm or the like, or may be configured as sweeping back and forth at a preset height of the conveying device according to a set manner to separate the stacked items.

In practical applications, this embodiment provides the following structure realization modes of the automatic billing system:

Mode One:

The weight detecting section is disposed at an inlet end of the conveying device, and is configured to detect a sum of weights of all the items to be checked out placed on the weight detecting section; the volume detecting section is disposed at an outlet end of the conveying device or at a side edge of the conveying device, and is configured to detect volume of a single item to be checked out after being separated by the conveying device. For example, the volume detecting section is measuring grating, and the mutually separated light emitter and light receiver included in the measuring grating are respectively disposed at two side edges of the conveying device as opposite to each other.

Of course, the weight detecting section is disposed at the inlet end of the conveying device, and the weight of each item to be checked out may be separately detected.

Mode Two:

The weight detecting section is disposed at an outlet end of the conveying device, and is configured to detect weight of a single item to be checked out after being separated by the conveying device; the volume detecting section is disposed at a side edge of the conveying device, and is configured to detect volume of a single item to be checked out after being separated by the conveying device.

If there are a plurality of items to be checked out, after being separated by speed difference of the differential steering conveyor, and being disturbed by the robot arm, the plurality of items to be checked out are no longer stacked, and they are separated from each other independently, so the weight detecting section can separately detect the weight of each item to be checked out.

Of course, the weight detecting section disposed at the outlet end of the conveying device may also collectively detect all the items to be checked out as conveyed by the conveying device, and obtain the weight of all the items.

In practical applications, locations of the physical information acquiring device (the weight detecting section and/or the volume detecting section), the image acquiring device, the conveying device or the like that may be possibly included in the automatic billing system may be flexibly set, for example, the weight detecting section is set at a front end, a rear end of the conveying device, or directly jointed with the conveying device, weight is measured at a preset position on the conveyor belt, and the weight detecting section may individually weigh each item or collectively weigh them all. Similarly, the volume detecting section may also be flexibly disposed at the front end, the rear end of the conveying device, or directly jointed with the conveying device, and the conveying device can separate the stacked items by the differential steering conveyor belt, the robot arm, or other ways, preferably, the volume detecting section is disposed in areas after where the stacked items are separated, so as to detect the volume of each single item.

Further, in order to facilitate the consumer directly obtaining the checked-out items and save the cumbersome process of self-package by the consumer, the system further comprises a bagging device configured to package checked-out items. The bagging device can automatically package the items into a bag, and the consumer can directly take the packaged items after checkout, which thereby greatly improves user experience.

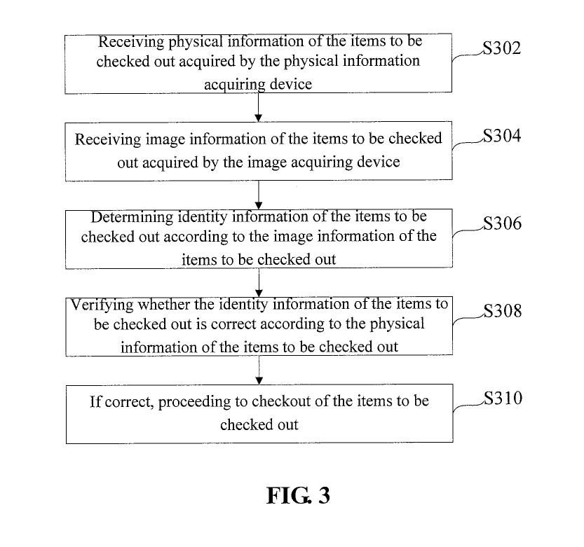

Referring to FIG. 3, FIG. 3 shows a flowchart of an automatic billing method applied to the automatic billing system provided by the foregoing embodiment. A person skilled in the art can clearly understand that, for the sake of convenience and brevity of description, as for detailed operating process of the automatic billing system, reference may be made to the corresponding process of the previous embodiment, details are not repeated herein again. The following describes the automatic billing method from the billing terminal side as an example, the following steps are comprised.

Step S302, receiving physical information of the items to be checked out acquired by the physical information acquiring device, the physical information including weight and/or volume.

Step S304, receiving image information of the items to be checked out acquired by the image acquiring device.

Step S306, determining identity information of the items to be checked out according to the image information of the items to be checked out.

Step S308, verifying whether the identity information of the items to be checked out is correct according to the physical information of the items to be checked out.

Step S310, if correct, proceeding to checkout of the items to be checked out.

In the method described above of this embodiment, physical information of items to be checked out is acquired by the physical information acquiring device, image information of the items to be checked out is acquired by the image acquiring device, identity information of the items to be checked out is recognized according to the image information, and whether the identity information is correct is further verified by adopting the physical information, if correct, it proceeds to checkout of the items to be checked out. This automatic billing manner determines item identity by way of image recognition, and verifies item identity through physical information such as weight, volume, etc., to ensure accuracy of item identification. Automatic billing can be achieved without cumbersome operations such as manual cooperative scanning, without the requirement to attach an electronic label with a relatively high cost to items, thereby ubiquitous applicability of items available for automatic billing is raised at a reasonable cost, and it is suitable for promotion and spreading.

It should be noted that, the above automatic billing method in the embodiment of the present disclosure is not limited to the specific order described in FIG. 3. It should be understood that, in other embodiments, the order of some of the steps may be interchanged according to actual needs, or some of the steps may be omitted or deleted. For example, there is no order of priority between step S302 and step S304.

In an implementation of this embodiment, the above step S306 may be executed by adopting the following steps:

comparing the image information of the items to be checked out with a central library of images pre-stored to determine the identity information of the items to be checked out; wherein the central library of images stores correspondence between the image information and the identity information of respective items.

Image information of all the items sold in the shopping facility, such as various views of the items, is stored in the central library of images, and item identity corresponding to the image information acquired by the image acquiring device can be identified through the central library of images. The image recognition technology may be specifically adopted to implement this, and details are not repeated herein again. Through this machine vision manner, identity of the items to be checked out can be known, and there is no need to manually scan codes one by one, and it is not necessary to attach a high-cost electronic tag to each item.

Considering the large number of item images contained in the central library of images, data amount is huge. In order to improve accuracy and efficiency of recognition, an effective solution is to reduce the number of images in the image library required for comparison in the item identification process. To this end, the billing terminal may also acquire a pre-selection list of the current person intended for checkout; the pre-selection list records identity information of pre-selected items during the shopping process by the person intended for checkout. Specifically, the billing terminal may obtain the pre-selection list of the current person intended for checkout locally, or may also obtain the pre-selection list of the current person intended for checkout through a server connected communicatively thereto.

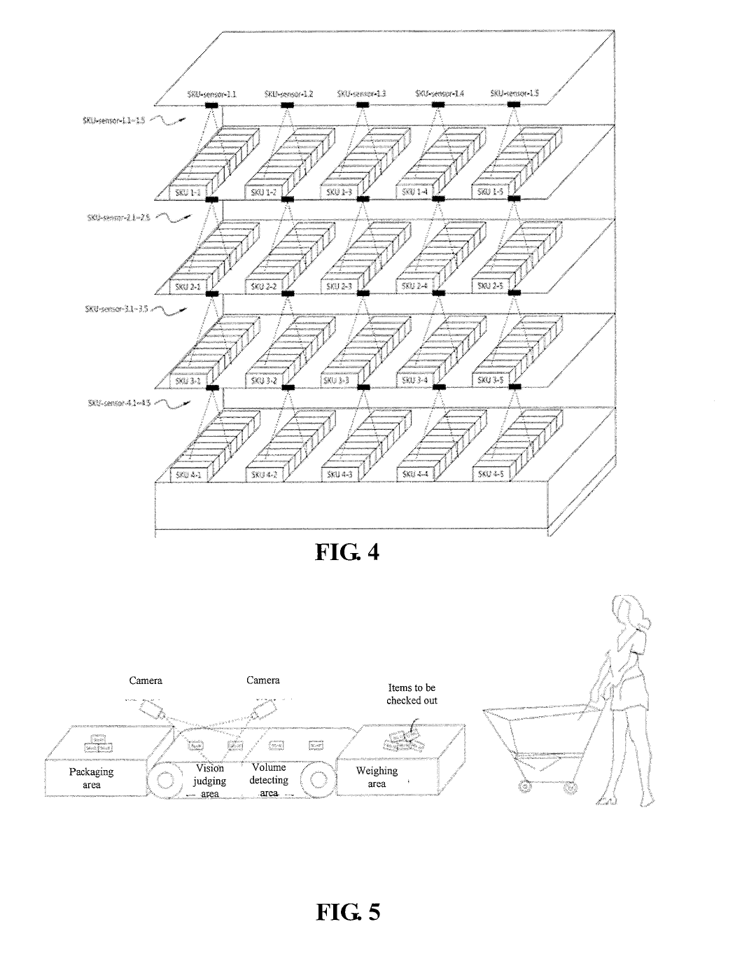

For ease of understanding, generation background of the pre-selection list is further described below. A plurality of distance sensors may be disposed on the shelf on which items are placed in the shopping facility, and each item on the shelf is located at least within a sensing area of a distance sensor. In practical applications, reference may be made to the schematic diagram of installation of the distance sensor on the shelf provided in FIG. 4. A plurality of distance sensors are disposed at an edge of each layer of partition of the shelf, and the sensing direction is perpendicular to the ground, forming a vertical distance sensor array (which may be simply referred to as a vertical distance sensor), and each item (SKU, Stock Keeping Unit) corresponds to at least one of the plurality of distance sensors, the larger, wider SKU may correspond to a plurality of distance sensors. In this implementation, the distance sensor is disposed at an outer edge of each layer of partition, regardless of whether the position where a certain SKU resides is full, the consumer's hand needs to reach into the shelf to get an item, and all the distance sensors disposed at the edge can sense the corresponding signal.

The plurality of distance sensors are connected to a processing device such as a gateway, wherein the distance sensor includes but not limited to a ToF ranging sensor, an ultrasonic sensor, an infrared light switch, a microwave ranging sensor, etc., and the distance sensor can detect an object in the sensing area, generate corresponding detection information (such as a signal or a value) and send the detection information to the processing device. The processing device associates the target object (the customer, equivalent to the person intended for checkout in this embodiment) and the items by the following method:

Step 1: determining identity of the distance sensor when it is monitored that distance information is generated as the distance sensor is triggered by a target object.

When the target object picks up, returns and touches an item, the distance sensor will be triggered to generate the corresponding distance information. Each distance sensor corresponds to a unique identity and an installation location, this identify may be a code number of the distance sensor. FIG. 4 also shows each distance sensor corresponds to a unique code number. When the processing device detects that the distance sensor is triggered by the target object to generate corresponding distance information, information of the distance sensor can be searched out, such as the installation location of the distance sensor, and the items monitored by the distance sensor, etc., by means of determining the identity of the distance sensor.

Step 2: determining an item corresponding to the distance sensor according to the identity of the distance sensor.

In the embodiment of the present disclosure, a specific implementation of determining an item corresponding to the distance sensor is provided: (1) determining an installation location of the distance sensor on the shelf according to the identity of the distance sensor and the pre-stored correspondence between the distance sensor and the installation location; (2) determining the item located in the sensing area of the distance sensor based on the installation location. Specifically, a server that is wirelessly, communicatively connected to the processing device may be queried for the item corresponding to the installation location; or a storage yard database locally established by the processing device is queried for the item corresponding to the installation location. At the server or locally, correspondence between the installation location of the distance sensor and the item located in the sensing area of the distance sensor is stored. As shown in FIG. 4, each distance sensor and the item at each location respectively have a unique code number. Specifically, the code number of the distance sensor and the code number of the item may be associated in the correspondence.

Step 3: associating the target object with the item corresponding to the distance sensor.

That is, association of the target object and the item corresponding to the distance sensor is established, and the target object may be associated with a plurality of items at the same time. The processing device may store, record the association information in a designated area. Of course, when the processing device is connected to the server, the association information may also be uploaded to the server.

The processing device mentioned above can determine whether the target object such as the consumer enters the sensing area of the distance sensor according to the distance information of the distance sensor, and associate the item corresponding to the distance sensor with the target object. This manner can not only determine the item contacted by the consumer, but also has a low cost and is suitable for promotion and spreading.

After the processing device associates the target object and the item, a pre-selection list may be generated, and the pre-selection list includes information of the item associated with the target object. The processing device sends the generated pre-selection list to the server, so that the automatic billing system acquires the pre-selection list corresponding to the current person intended for checkout (the above-mentioned target object) from the server.

In another implementation, based on the above pre-selection list, said step S306 may be executed by the following steps:

(1) Extracting, according to the identity information of the pre-selected items, image information of the pre-selected items from a central library of images pre-stored, generating an image pre-selection library that includes only image information of the pre-selected items, and correspondence between the image information and the identity information of the pre-selected items; and

(2) Comparing the image information of the items to be checked out and the image pre-selection library, and determining the identity information of the items to be checked out.

Since only the items touched by the current person intended for checkout during the shopping process are recorded in the pre-selection list, it can be understood that, the items that the current person intended for checkout needs to check out belong to the items contacted by him/her, thus, through the pre-selection list, the items to be checked out can be directly compared with the items touched during the shopping process, rather than being compared with all the items in the total library of images, which greatly reduces the recognition range and improves accuracy and efficiency of item identification.

In the automatic billing system provided by this embodiment, in order to improve accuracy of item identification, not only the machine vision manner is adopted to recognize identify of the item, but also the physical information verifying manner is adopted to verify whether the item identity is correctly recognized, or whether an abnormality has occurred to the item.

For the above step S308, this embodiment provides a verification manner:

(1) Searching, in an item database pre-stored, for reference physical information corresponding to the items to be checked out; wherein the item database stores correspondence between items and reference physical information of the items; the reference physical information is actual physical information of the items.

(2) Determining whether a difference between the physical information of the items to be checked out and the reference physical information corresponding to the items to be checked out is within a preset difference range; if yes, determining that the identity information of the items to be checked out is correct. Specifically, the preset difference may include a weight preset difference, a volume preset difference, or the like, respectively. Exceeding the difference indicates an abnormality.

The physical information includes volume and weight. For the volume, it may be determined whether the difference between the volume of a single item to be checked out and the reference volume of the single item to be checked out is within a preset first difference range.

For the weight, in an application, it may be determined whether the difference between the sum of weights of a plurality of items to be checked out and the sum of the reference weights of the plurality of items to be checked out is within a preset second difference range. In another application, it may also be determined whether the difference between the weight of each of the items to be checked out and the reference weight of the single item to be checked out is within a preset third difference range.

When each determination result is yes, it is determined that the difference between the physical information of the items to be checked out and the reference physical information corresponding to the identity information of the items to be checked out is within a preset difference range.

For ease of understanding, an example is provided herein, one item A with an external package box (wherein A is identity information of the item), and the reference physical information recorded in the item database is weight 500 g; the machine vision recognition confirms that the item to be checked out is item A, but the physical information acquiring device acquires the weight of the item as 1000 g, and the weight difference is obvious, thus it can be determined that identity of this item is incorrect, or the shopping is abnormal, and there may be a risk that the item inside is replaced. In addition, for a light-weight item, such as puffed food of only 50 g, whether its identity is correct may be determined by volume verification.

The multi-dimensional detection manner based on image recognition and physical information can determine identity of the item more accurately and reliably, and the manner of verifying identity of the item through the physical information can also detect abnormality, so as to prompt a relevant personnel to pay attention.

On basis of that the pre-selection list of the current person intended for checkout is acquired, the above method may also perform the following steps:

a) summarizing the identity information of the items to be checked out to generate a billing list;

b) determining whether a difference between the billing list and the pre-selection list is higher than a preset degree; and

c) if yes, generating alert information.

If the difference between the billing list and the pre-selection list is too large, there may be a risk such as theft, so the corresponding alert information can be generated to prompt the seller to pay attention.

Based on the foregoing embodiments, this embodiment provides a specific application scenario. Referring to the schematic diagram of structure of an automatic billing system shown in FIG. 5, the physical information acquiring device, the image acquiring device and the conveying device shown in the second embodiment are comprised. Specifically, the physical information acquiring device includes a weight detecting section and a volume detecting section.

As shown in FIG. 5, the area corresponding to the weight detecting section is a weighing area, it may be a weighing platform or the like in particular. In this embodiment, the weighing area is placed at the inlet of the automatic billing system as a first link in the automatic billing process. In the automatic billing system of FIG. 5, the current person intended for checkout can stack all the items to be checked out in the shopping cart in the weighing area, and the weight detecting section acquires the total weight of all items to be checked out. In this case, there is no need for the person intended for checkout to take out the items one by one, and he/she can just stack them directly, which is simple and convenient.

After acquiring the total weight of all the items in the weighing area, all the items enter the conveying device connected with the weighing area, as shown in FIG. 5, the volume of each item can be detected in the volume detecting area on the conveying device. In view of the fact that a plurality of items may be stacked, the conveying device may be implemented by adopting a differential steering conveyor belt, at the same time, a robot arm may be provided in front of the volume detecting area on the conveying device to disturb the items to separate them. The volume detecting area may be disposed in a conveyor belt portion after where the items are separated. For the sake of brevity, the robot arm and the specific volume detecting section are not provided in FIG. 5, in practice, measuring grating may be adopted to realize this, and the two separated light emitter and light receiver included in the measuring grating are disposed on two opposite side edges of the conveying device, specifically, being disposed on two side edges of the volume detecting area of the conveying device.

With the automatic billing system shown in FIG. 5, the items to be checked out enter the vision judging area after their weight and volume are acquired, and the image acquiring device (many cameras) acquires images of the items to be checked out and sends them to the billing terminal for identification. The billing terminal confirms identity of the items to be checked out based on the image information, the weight and the volume of the items to be checked out, thereby realizing billing settlement. Eventually, all the checked out items are packaged in the packaging area of the automatic billing system.

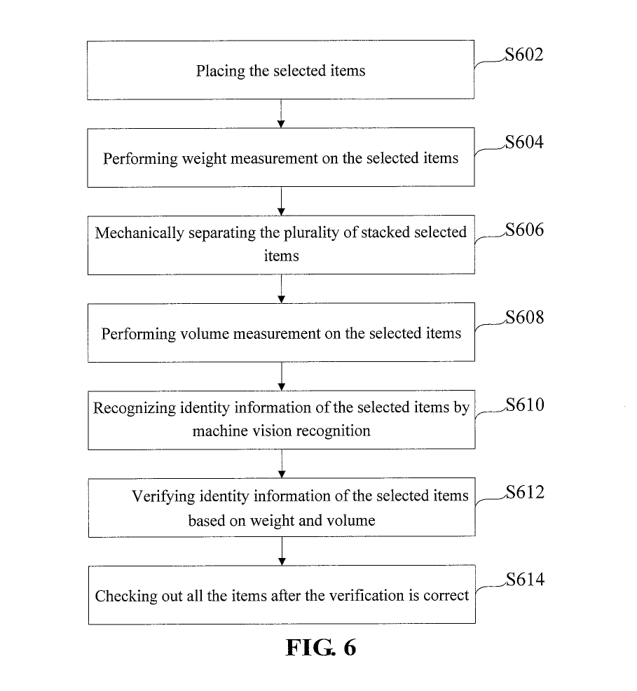

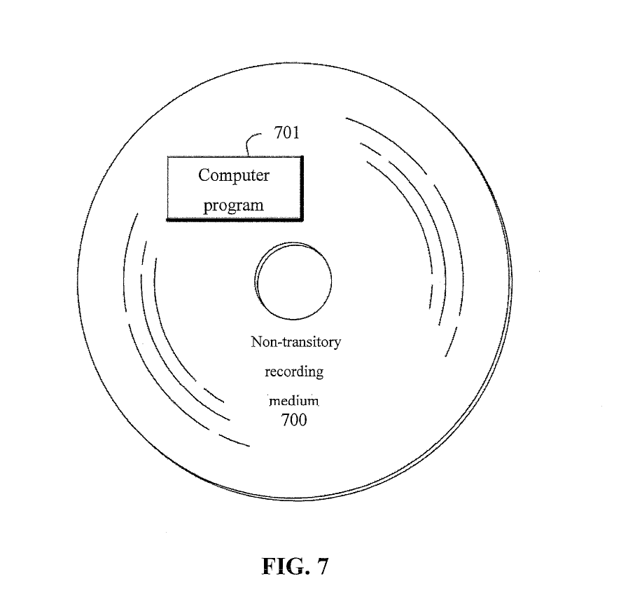

Based on the automatic billing system shown in FIG. 5, reference may be made to a flowchart of automatic billing method shown in FIG. 6, including the following steps:

Step S602: placing the selected items.

Step S604: performing weight measurement on the selected items.

Step S606: mechanically separating the plurality of stacked selected items.

Step S608: performing volume measurement on the selected items.

Step S610: recognizing identity information of the selected items by machine vision recognition.

Step S612: verifying identity information of the selected items based on weight and volume.

Step S614: checking out all the items after the verification is correct.

With the above manner, the person intended for checkout can directly place the selected items on the automatic billing system, the items are identified by the automatic billing system, and the identity recognized is double-verified through weight and volume, etc., items are verified comprehensively through dimensional factors, such as image, weight and volume, to ensure accuracy of the billing. In the above manner, the person intended for checkout does not need to take each item to scan the code one by one, and does not need to attach an electronic label to each item, so that the items can be accurately identified, and the items are automatically checked out, which improves user experience.

In practical applications, when the acquired physical information of the items to be checked out is used to verify the identity information of the items to be checked out as recognized based on machine vision, the specific verification method is as follows:

(1) Weight verification. Since the automatic billing system shown in this embodiment performs centralized weighing on all the items, the reference weights corresponding to the recognized identity information of all the items to be checked out can be summed, and then compared with the actual total weight, to determine whether a weight difference is within an acceptable preset range. That is, the total weight verification is performed.

(2) Volume verification. Since the automatic billing system shown in this embodiment separately measures the volume of each separated item, the reference volume corresponding to the recognized identity information of each item to be checked out can be compared with the actual volume of each item, to determine whether a volume difference is within an acceptable preset range. That is, one-by-one verification is performed.

Alert information is issued if one of said verification is not met.

Of course, the above is only for the structure of the automatic billing system shown in FIG. 5 of this embodiment. In practical applications, the physical information acquiring device (weighing area) in the automatic billing system may also individually weigh each item, and the person intended for checkout needs to put down the items one by one. Further, the weighing area may be also disposed after where the items are separated by the conveying device, such as being jointed with the volume detecting area, or at a front and rear position of the volume detecting area, thereby weighing the individual item. In practical applications, the weight detecting section and the volume detecting section of the physical information acquiring device, the image collecting device, and the conveying device may have various position setting manners, and may be flexibly set according to requirements.

A person skilled in the art can clearly understand that, for convenience and brevity of description, as for the specific working process of the system described in this embodiment, reference may be made to the corresponding process in the foregoing embodiments, details are not repeated herein.

This embodiment further provides a non-transitory recording medium on which a computer program is stored, wherein steps of the method described above in the foregoing embodiments are executed when the computer program is run by a processing device.

The computer program products of the automatic billing system and the automatic billing method provided by the embodiments of the present disclosure includes a computer-readable storage medium storing program codes, and the program codes include instructions for executing the method described in the above method embodiments. As for specific implementations, reference may be made to the method embodiments, details are not repeated herein.

In addition, in description of the embodiments of the present disclosure, unless otherwise expressly specified and limited, the terms “installation”, “connected”, “connection” should be broadly understood, for example, it may be fixedly connected, or removably connected, or integrally connected; it may also be mechanically connected, or electrically connected; it may also be directly connected, or indirectly connected through an middleware, or two components may be internally communicated. For a person of ordinary skill in the art, the specific meaning of the aforesaid terms in the present disclosure should be understood according to practice.

The above functions may also be stored in one computer-readable storage medium when being implemented in the form of a software functional module and sold and used as an independent product. Based on such understanding, the substance or the part that contributes to the prior art of the technical solutions of the present disclosure or the technical solution part may be reflected in the form of a software product, the computer software product may be stored in one storage medium, and include several instructions for causing a computer device (which may be a personal computer, a server, or a network device) to fully or partially perform the method described in the various embodiments of the present disclosure. The aforesaid storage medium includes various mediums capable of storing program codes like a mobile storage device, a Read Only Memory (ROM), a magnetic disk, or an optical disk.

In description of the present disclosure, it should be noted that, orientation or positional relationship indicated by the terms “center”, “upper”, “lower”, “left”, “right”, “vertical”, “horizontal”, “inside”, “outside”, etc. are orientation or positional relationship based on the drawings, which are merely for convenience of describing the present disclosure and simplifying the description, rather than indicating or implying that the device or component referred to must have a specific orientation, or must be constructed and operated with a specific orientation, they should not be construed as limiting the present disclosure. Moreover, the terms “first”, “second” and “third” are used for descriptive purposes only and are not to be construed as indicating or implying relative importance.

Last, it should be noted that, the above embodiments are merely specific implementations adopted for explaining the technical solutions of the present disclosure, rather than limiting the present disclosure, the protection scope of the present disclosure is not limited thereto. Although the present disclosure has been described in detail with reference to the above embodiments, a person of ordinary skill in the art should understand that, within the technical scope revealed by the present disclosure, various modifications may also be made to the technical solutions recorded in the preceding embodiments or changes may be made thereto easily, or parts of the technical features thereof may be replaced by equivalents, and essence of the corresponding technical solutions with these modifications or replacements still falls into the spirit and scope of the technical solutions in the embodiments of the present disclosure. These modifications, changes, and substitutions do not make the corresponding technical solutions depart from the spirit and scope of the technical solutions in the embodiments of the present disclosure, they should be within the protection scope of the present disclosure. Therefore, the protection scope of the present disclosure should be determined by the scope of the appended claims.

What is claimed is:

1. An automatic billing system, comprising: a billing terminal, as well as a physical information acquiring device and an image acquiring device connected to the billing terminal respectively;
the physical information acquiring device is configured to acquire physical information of items to be checked out, and send the acquired physical information to the billing terminal;
the physical information including weight and/or volume;
the image acquiring device is configured to acquire image information of the items to be checked out, and send the acquired image information of the items to be checked out to the billing terminal;
the billing terminal is configured to determine identity information of the items to be checked out according to the acquired image information of the items to be checked out, and further, to verify whether the identity information of the items to be checked out is correct according to the acquired physical information of the items to be checked out; if correct, proceed to checkout of the items to be checked out.

2. The automatic billing system according to claim 1, wherein the physical information acquiring device comprises a weight detecting section and/or a volume detecting section.

3. The automatic billing system according to claim 2, wherein the volume detecting section comprises measuring grating and/or an opposite-type photoelectric sensor array.

4. The automatic billing system according to claim 2, wherein the system further comprises a conveying device configured to convey the items to be checked out.

5. The automatic billing system according to claim 4, wherein the conveying device comprises a differential steering conveying device configured to separate a plurality of stacked items to be checked out in the process of conveying the items to be checked out.

6. The automatic billing system according to claim 4, wherein the conveying device is further provided with a robot arm for separating a plurality of stacked items to be checked out.

7. The automatic billing system according to claim 6, wherein the weight detecting section is disposed at an inlet end of the conveying device, and is configured to detect a sum of weights of all the items to be checked out placed on the weight detecting section;
the volume detecting section is disposed at an outlet end of the conveying device or at a side edge of the conveying device, and is configured to detect volume of a single item to be checked out after being separated by the conveying device.

8. The automatic billing system according to claim 6, wherein the weight detecting section is disposed at an outlet end of the conveying device, and is configured to detect weight of a single item to be checked out after being separated by the conveying device;
the volume detecting section is disposed at a side edge of the conveying device, and is configured to detect volume of a single item to be checked out after being separated by the conveying device.

9. The automated billing system according to claim 1, wherein the system further comprises a bagging device configured to package the checked-out items.

10. An automatic billing method, the method being applied to an automatic billing system that includes a billing terminal as well as a physical information acquiring device and an image acquiring device connected to the billing terminal respectively, the method comprising:
receiving physical information of the items to be checked out acquired by the physical information acquiring device, the physical information including weight and/or volume;
receiving image information of the items to be checked out acquired by the image acquiring device;
determining identity information of the items to be checked out according to the image information of the items to be checked out;
verifying whether the identity information of the items to be checked out is correct according to the physical information of the items to be checked out; and
if correct, proceeding to checkout of the items to be checked out.

11. The automatic billing method according to claim 10, wherein the step of determining identity information of the items to be checked out according to the image information of the items to be checked out comprises:
comparing the image information of the items to be checked out with a central library of images pre-stored to determine the identity information of the items to be checked out; wherein the central library of images stores correspondence between the image information and the identity information of respective items.

12. The automatic billing method according to claim 10, wherein the method further comprises:
obtaining a pre-selection list of a current person intended for checkout, identity information of pre-selected items of the person intended for checkout in the shopping process being recorded in the pre-selection list;
the step of determining identity information of the items to be checked out according to the image information of the items to be checked out comprises:
extracting, according to the identity information of the pre-selected items, image information of the pre-selected items from a central library of images pre-stored, generating an image pre-selection library that includes only image information of the pre-selected items, and correspondence between the image information and the identity information of the pre-selected items; and
comparing the image information of the items to be checked out and the image pre-selection library, and determining the identity information of the items to be checked out.

13. The automatic billing method according to claim 10, wherein the step of verifying whether the identity information of the items to be checked out is correct according to the physical information of the items to be checked out comprises:
searching, in an item database pre-stored, for reference physical information corresponding to the items to be checked out; wherein the items database stores correspondence between items and the reference physical information of the items;
determining whether a difference between the physical information of the items to be checked out and the reference physical information corresponding to the items to be checked out is within a preset difference range;
if yes, determining that the identity information of the items to be checked out is correct.

14. The automatic billing method according to claim 12, wherein the method further comprises:
summarizing the identity information of the items to be checked out to generate a billing list;
determining whether a difference between the billing list and the pre-selection list is higher than a preset degree;
if yes, generating alert information.

15. A non-transitory recording medium on which a computer program is stored, wherein steps of an automatic billing method are executed when the computer program is run by a processing device, the method being applied to an automatic billing system that includes a billing terminal as well as a physical information acquiring device and an image acquiring device connected to the billing terminal respectively, the method comprising:
receiving physical information of the items to be checked out acquired by the physical information acquiring device, the physical information including weight and/or volume;
receiving image information of the items to be checked out acquired by the image acquiring device;
determining identity information of the items to be checked out according to the image information of the items to be checked out;
verifying whether the identity information of the items to be checked out is correct according to the physical information of the items to be checked out; and
if correct, proceeding to checkout of the items to be checked out.

16. The non-transitory recording medium according to claim 15, wherein the step of determining identity information of the items to be checked out according to the image information of the items to be checked out comprises:
comparing the image information of the items to be checked out with a central library of images pre-stored to determine the identity information of the items to be checked out; wherein the central library of images stores correspondence between the image information and the identity information of respective items.

17. The non-transitory recording medium according to claim 15, wherein the method further comprises:
obtaining a pre-selection list of a current person intended for checkout, identity information of pre-selected items of the person intended for checkout in the shopping process being recorded in the pre-selection list;
the step of determining identity information of the items to be checked out according to the image information of the items to be checked out comprises:
extracting, according to the identity information of the pre-selected items, image information of the pre-selected items from a central library of images pre-stored, generating an image pre-selection library that includes only image information of the pre-selected items, and correspondence between the image information and the identity information of the pre-selected items; and
comparing the image information of the items to be checked out and the image pre-selection library, and determining the identity information of the items to be checked out.

18. The non-transitory recording medium according to claim 15, wherein the step of verifying whether the identity information of the items to be checked out is correct according to the physical information of the items to be checked out comprises:
searching, in an item database pre-stored, for reference physical information corresponding to the items to be checked out; wherein the items database stores correspondence between items and the reference physical information of the items;
determining whether a difference between the physical information of the items to be checked out and the reference physical information corresponding to the items to be checked out is within a preset difference range;
if yes, determining that the identity information of the items to be checked out is correct.

19. The non-transitory recording medium according to claim 15, wherein the method further comprises:
summarizing the identity information of the items to be checked out to generate a billing list;
determining whether a difference between the billing list and the pre-selection list is higher than a preset degree;
if yes, generating alert information.
